(19) United States
(12) Patent Application Publication
(10) Pub. No.: US 2006/0087853 A1
(43) Pub. Date: Apr. 27, 2006

(54) Stand for various equipment, including lights, and methods

(76) Inventors: Eric Neumann, Inver Grove Heights, MN (US); Peter H. Johannsen, West St. Paul, MN (US); Tara Neumann, Inver Grove Heights, MN (US)

Correspondence Address: Mara E. DeBoe;Merchant & Gould P.C., P.O. Box 2903, Minneapolis, MN, 55402-0903, US

(21) Appl. No.: 11/253,287

(22) Filed: Oct. 17, 2005

Related U.S. Application Data
(60) Provisional application No. 60/618,950, filed on Oct. 15, 2004.

(51) Int. Cl. F21V 33/00; F21V 21/36

(52) U.S. Cl. 362/391; 362/127; 362/134

(57) ABSTRACT

The present invention is directed to a stand, such as a lighting stand used by disc jockeys and other entertainers to illuminate any portion of a stage, their work station or equipment, or the dance floor. The invention is directed to a stand that has hollow structural elements, through which electrical wires and other cables and wires can be passed therethrough. By passing the wires and cables through the structural elements, rather than on the exterior of the structural elements, a more neat and tidy stand is obtained.

This application claims priority under 35 U.S.C. § 119(e) to U.S. provisional application Ser. No. 60/618,950, filed Oct. 15, 2004 and entitled “Lighting Stand Having Electrical Wiring for Lights and Other Electrical Equipment Passing Therethrough”. The entire disclosure of 60/618,950 is incorporated herein by reference.

### FIELD OF THE INVENTION

The present invention is directed to a stand for supporting equipment. For example, the stand is a lighting stand such as used by D.J.s and other entertainers to illuminate any of a stage, their work station, or the dance floor.

### BACKGROUND

Lighting stands are commonly used by disc jockeys and other entertainers to illuminate stages, work stations, or dance floors. Such lighting stands often support a large number and type of lights including strobe lights, work lights, or moving colored lights. Additionally, lighting stands can be configured to support other electrical equipment such as speakers, microphones, or fog machines.

These lighting stands can often be disassembled into discrete structural elements between uses to maximize their portability.

Because of the large number of components that can potentially be mounted on a lighting stand, a potential exists for a large number of cables to be stringing from the lighting stand during use. Such cables can include electrical wires, audio cables, video cables, or other connective cables.

Disc jockeys and other users of lighting stands often wish to organize the cables stringing from such stands for safety and aesthetic reasons. When used in an entertainment setting, a neat appearance is important in creating an overall enjoyable effect. Further, a large number of cords strung from an area in which a large number of people congregate might present a hazard to safety and could cause damage to the elements mounted on the lighting stand. Users of lighting stands, such as disc jockeys, generally attach the cords to the structural elements of the lighting stand, for example with zip ties or other easily removable fixation devices. However, when such ties are used the cords remain visible and the ties themselves are not aesthetically pleasing.

Therefore improvements are desirable.

### SUMMARY

The present invention is directed to a stand, such as a lighting stand used by disc jockeys and other entertainers to illuminate any portion of a stage, their work station or equipment, or the dance floor. The invention is directed to a stand that has hollow structural elements, through which electrical wires and other cables and wires can be passed therethrough. By passing the wires and cables through the structural elements, rather than attaching the cables to the exterior of the structural elements, a more neat and tidy stand is obtained.

The stand of the invention consists of the full structure necessary to support lights and/or other equipment. Generally it will include multiple structural elements and support members. In the stand of the invention, at least some of the structural elements that form the support stand are hollow, meaning, they have a wall and an interior generally void of features that might interfere with passing of wires or cables therethrough.

The structural elements, when assembled, should be sufficiently rigid and stable to support peripheral equipment, such as lights, speakers, mirrors, and other equipment. Structural elements are the primary members of the lighting stand that define the shape of the stand. Support members may be connected between the structural elements to assist in supporting the rigid shape of the stand.

Generally, the stand can be collapsed or disassembled, to facilitate moving the stand from one location to another. The wires retained within the hollow volumes of the structural elements can be removed from the elements when the stand is collapsed or disassembled, or, the wires can be configured with connectors (such as a plug and a receptacle), generally at the element unions, to allow the stand to be disassembled while retaining the wires within the structural elements.

In some designs, all of the elements of the stand have hollow volumes, although it is understood that the stand could have some elements that are not hollow.

In various applications, the stand of the invention is termed a lighting stand, a speaker stand, or an electrical stand. It is understood that this stand configuration, having hollow volumes therethrough for passing, for example, electrical wires and other wires and cables therethrough, can be used for other applications, rather than just being limited to lighting and speakers for music or other displays. The term lighting stand encompasses a stand capable of holding lights, but additionally and alternately capable of holding other electrical equipment.

### BRIEF DESCRIPTION OF THE DRAWINGS

FIG. 1 is a perspective view of a stand configured and illustrated in use with a disc jockey;

FIG. 2 is a perspective view of a section of a hollow structural element according to a possible embodiment;

FIG. 3 is a perspective view of a section of a hollow structural element formable from two detached hollow structural segments according to a possible embodiment;

FIG. 4 is a perspective view of a section of a hollow structural element formable from two detached hollow structural segments according to another possible embodiment;

FIG. 5 shows a section of a lighting stand according to a possible embodiment;

FIG. 6 is a close-up view of a section of a lighting stand;

FIG. 7 is a close-up view of a section of a lighting stand;

FIG. 8 shows a section of a lighting stand with an integrated receptacle manifold; and

FIG. 9 is a perspective view of a section of a hollow structural element according to a possible embodiment.

### DETAILED DESCRIPTION OF THE PREFERRED EMBODIMENT

The present invention is directed generally to a stand, such as a lighting stand used by disc jockeys and other entertainers to illuminate any portion of a stage, their work station or equipment, or the dance floor. The invention is more specifically directed to a stand that has hollow structural elements, through which electrical wires or other cables and wires can be passed therethrough. By passing the wires and cables through the interior of the structural elements, rather than on the exterior of the structural elements, a more neat and tidy stand is obtained. Although not required, in some designs all of the elements of the stand have hollow volumes. In such designs, the wires and cables can be passed throughout the structure of the lighting stand.

It is preferred that the stand can be disassembled or collapsed for easier transportation. In such designs, the wires and cables can be removable, or can incorporate connectors to allow disassembly or folding of the stand at structural unions.

In some designs the connectors reside at least partially in the interior of the stand structure. In such designs, the connector has a connection area that is accessible external to the stand.

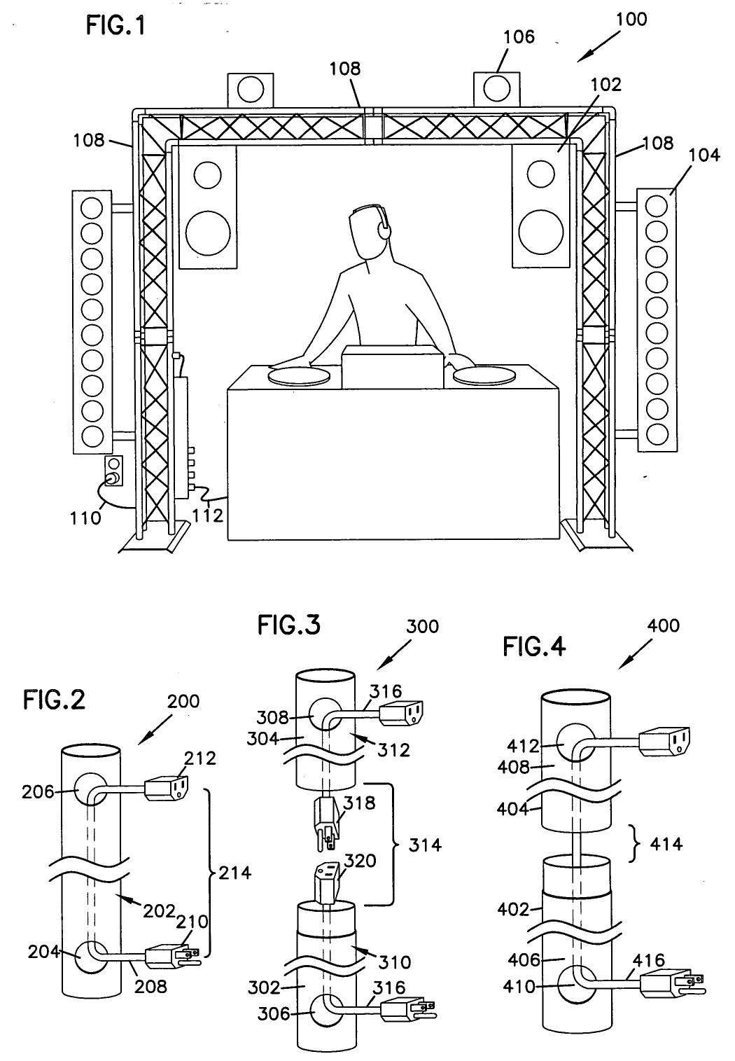

Referring now to FIG. 1, a perspective view of a stand 100 is shown according to a possible embodiment of the present disclosure. The stand 100 can support, for example, speakers 102, flashing lights 104 of various colors, or strobe lights 106. The stand 100 is made from at least one structural element 108, usually at least three and often more. In accordance with this invention, at least some of the structural elements are hollow. In the embodiment shown, all structural elements 108 include a hollow portion. In the stand of the invention, at least some of the structural elements that form the light support stand are hollow, meaning, they have a wall and an interior generally void of features that might interfere with passing of wires or cables therethrough.

As shown in the following figures, the stand 100 is configured to hide cables and provide an aesthetically pleasing and safe environment. Cables could include, for example, power cords 110 or audio/video cables 1112. Of course, other cables, such as specialized speaker cables or other communications cables could be used consistent with the present disclosure as well. Cables or wires could be audio, video, alternating current, direct current, or low voltage electrical connections.

Generally, the stand 100 can be collapsed or disassembled, to facilitate moving the stand from one location to another. This collapsing or disassembling of the stand 100 could be accomplished, for example, by folding or detaching the structural elements 108. The structural elements 108, when assembled, should be sufficiently rigid and stable to support peripheral equipment, such as lights, speakers, mirrors, and other equipment.

In one possible embodiment (discussed in more depth in conjunction with FIG. 3, below), the cables can be configured with complementary connectors at the element joints. For example, an electrical plug and an electrical receptacle can be provided at complementary joints to allow for disassembly and reassembly or collapsing and resetting.

In another possible embodiment (discussed in more depth in conjunction with FIG. 4, below), the wires retained within the hollow volumes of the structural elements can be removed from the elements when the stand is collapsed or disassembled.

Now referring to FIG. 2, a perspective view of a section of a hollow structural element 200 is shown according to a possible embodiment. One or more hollow structural elements 200 form part of an overall lighting stand, such as the one disclosed in FIG. 1. Each hollow structural element has an internal volume 202. The internal volume is defined by the unoccupied space within the hollow structural element 200. The element 200 has a first cable access opening 204 and a second cable access opening 206. These openings 204, 206 are spaced along the length of the hollow structural element. Preferably at least one of the openings 204, 206 should be located at a non-end of the hollow structural element 200.

At least one cable 208 resides at least partially in the internal volume 202. The cable 208 has first and second connectors 210, 212. In the embodiment shown, the first and second connectors 210, 212 are an electrical plug and an electrical receptacle, respectively. The cable 208 is preferably of a length greater than a predetermined length 214 between the openings 204, 206, such that the first and second connectors 210, 212 are concurrently accessible external to the hollow structural element 200.

The hollow structural element 200 shown is tubular in form and having a circular cross section. However, the element 200 could have a cross sectional shape that is rectangular, oval, or any other shape, so long as it is sufficiently rigid to support the lighting stand, and provides sufficient internal volume 202 to accept at least one cable 208.

The openings 204, 206 are of sufficient size to allow the cable 208 to pass through the opening. Further, in embodiments for which it is desirable that the cable 208 is removable from the hollow structural elements 200, the openings 204, 206 should be larger than at least one of the connectors 210, 212, so that the connector can pass through and the cable 208 can be removed.

Referring now to FIG. 3, a perspective view of a section of a hollow structural element 300 is shown according to a possible embodiment of the present disclosure. In the embodiment shown, the hollow structural element 300 is formed from two detachable hollow structural segments 302, 304. Each hollow structural segment 302, 304 has a cable access opening 306, 308, respectively. Each hollow structural segment 302, 304 also defines an internal volume 310, 312, respectively.

The hollow structural segments 302, 304 are connectable at a union 314. The union 314 encompasses all of the structural and electrical connections necessary to form a complete structural element 300 capable of supporting a lighting stand such as the one disclosed in FIG. 1 without removing the cable 316. Specifically, this requires physical and electrical connective elements. Electrical elements include connectors, such as the electrical plug 318 and electrical receptacle 320 shown proximate to the union 314. When the structural segments 302, 304 are joined at the union 314, internal volumes 310, 312 are combined to form a larger internal volume analogous to the internal volume disclosed in FIG. 2. Likewise, when the structural segments 302, 304 are joined at the union 314, connectors such as electrical plug 318 and electrical receptacle 320 are combined to form the overall cable 316 as disclosed in FIG. 2. By using multiple structural segments 302, 304 such as those disclosed, one or more structural elements can be disconnected or reconnected to form the stand. This allows the lighting stand to be collapsed or disassembled and reassembled by a user of the stand for ease of transportation.

Now referring to FIG. 4, a perspective view of a section of a hollow structural element 400 is shown according to another possible embodiment of the present disclosure. In the embodiment shown, the hollow structural element 400 is formed from two detachable hollow structural segments 402, 404. The hollow structural segments 402, 404 each define an internal volume 406, 408, respectively. The hollow structural segments 402, 404 each also have a cable access opening 410, 412 along the length of each element.

The hollow structural segments 402, 404 are connectable at a union 414. The union encompasses the structural connections necessary to form a complete structural element 400 capable of supporting a lighting stand such as the one disclosed in FIG. 1. When the structural segments 402, 404 are joined at the union 414, internal volumes 406, 408 are combined to form a larger internal volume analogous to the internal volume disclosed in FIG. 2.

A cable 416 is fed through the cable access openings 410, 412 such that a portion of the cable resides in the internal volume of the hollow structural element 400 to form the overall structure contemplated, for example, by FIG. 2. By using multiple structural segments such as those disclosed in a lighting stand, one or more structural elements can be disconnected for ease of transportation of the stand. When the stand is disassembled, the cable 416 is removable from the hollow structural element 400.

In alternate embodiments not shown, the hollow structural element can have more than two cable access openings, and the openings can be placed at various locations along the element. In such embodiments, multiple cables reside at least partially within the internal volume and can be accessed at various locations along the hollow structural element. In some embodiments, a hollow structural element may have only one cable access opening, or more depending on the stand configuration desired and the needed placement of plugs, receptacles, or other connectors.

In further embodiments not shown, the hollow structural elements forming the stand are collapsible at one or more unions for ease of transport.

Referring now to FIG. 5, a section of a lighting stand 500 is shown according to a possible embodiment of the present disclosure. Two hollow structural elements 502 are shown on the section of the lighting stand 500. The hollow structural elements 502 are held in parallel by one or more support bars 504. In the embodiment shown, the support bars 504 are solid and connect to the hollow structural elements at 45-degree angles to form alternating right triangles defined by two support bars 504 as legs and a section of the hollow structural element 502 as the hypotenuse.

Alternative configurations of the support bars 504 and hollow structural elements 502 forming a lighting stand can be formed consistent with the present disclosure. For example, one or more support bars 504 can be removed from such embodiments or rearranged so long as the lighting stand is sufficiently rigid and stable to support the necessary lights, speakers and/or other equipment as required for the particular application of the lighting stand.

The hollow structural elements 502 preferably include multiple cable access openings 506. The cable access openings 506 are regularly spaced, and include an opening near the base of the lighting stand 500. At least one cable, such as electrical cord 508, resides at least partially in at least one of the hollow structural elements 502. Each cable has connectors at opposing ends, such as an electrical plug (not shown) and electrical receptacle 510 on electrical cord 508. An end of the cable can be passed through two cable access openings 506 such that the connectors protrude from the openings 506 and at least a portion of the cable resides within the hollow structural element 502.

Alternately, a single cable having more than two regularly spaced connectors can be used, each connector spaced along the cable at least as far apart as the cable access openings 506.

It is noted that the distance between the two cable access openings 506 is preferably less than the length of the cable to ensure that the connectors on opposing ends of the cable protrude from the openings 506, or at least are accessible through openings 506. In the embodiment shown, multiple electrical cords 508 enter an opening 506 in a hollow structural element 502 near the base of the lighting stand 500. The end of each cord 508 having the electrical receptacle 510 protrudes from an opening 506 in the element 502 remote from the opening 506 near the base of the stand 500.

Each electrical cord 508 can be substantially longer than the distance between two openings 506 to allow the cord 508 to extend, for example, to a wall outlet. If other types of cables, such as audio cables, are used, longer or shorter lengths are used to reach various audio/visual equipment such as a turntable, projector, lighting controls, or an amplifier.

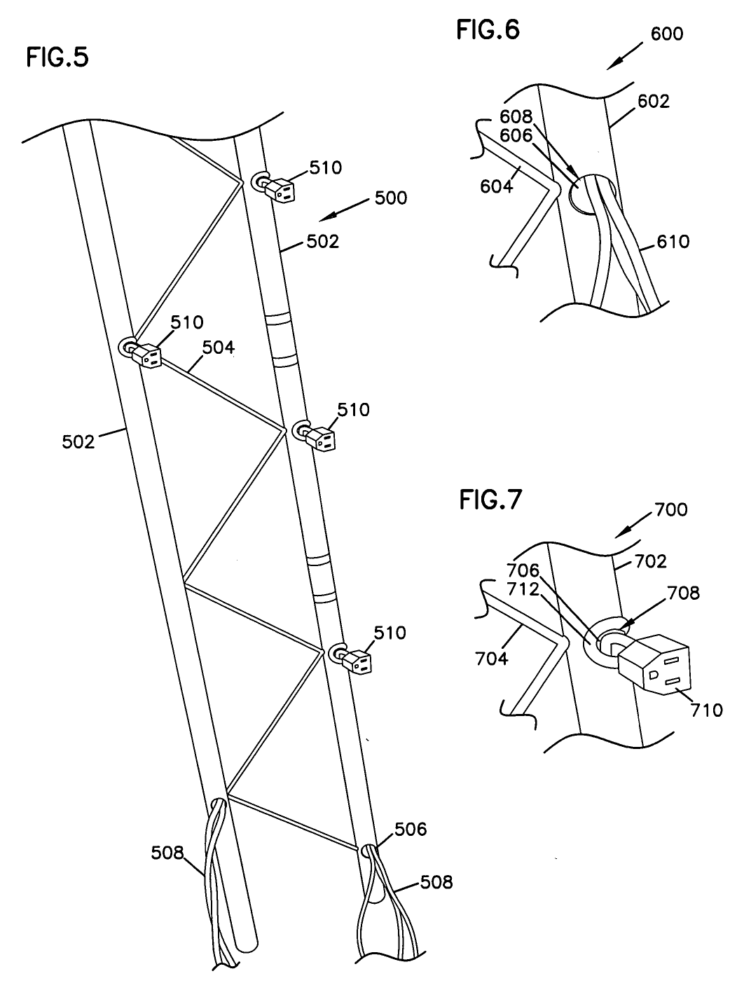

Referring now to FIG. 6, a close-up view of a portion of a lighting stand 600 is shown according to a possible embodiment of the present disclosure. The lighting stand 600 includes a hollow structural element 602. In the embodiment shown, the hollow structural element 602 is tubular in shape and having a circular cross section. The hollow structural element 602 is joined to one or more support bars 604. The support bars 604 provide structural integrity to the stand 600. In the embodiment shown, the support bars 604 are solid. The hollow structural element 602 and support bars 604 are formed from metal such as steel or aluminum, and can be joined by welding or other permanent connection process.

The hollow structural element 602 includes a cable access opening 606. The cable access opening 606 provides access to an interior volume 608 of the hollow structural element 602 at a non-end of the element 602. At least one cable 610 accesses the interior volume 608 of the hollow structural element 602 via the cable access opening 606.

Referring now to FIG. 7, a close-up view of a section of a lighting stand 700 is shown according to a possible embodiment of the present disclosure. The lighting stand 700 includes a hollow structural element 702. The hollow structural element 702 shown is tubular in shape, and is joined to one or more support bars 704.

The hollow structural element 702 includes a cable access opening 706. The cable access opening 706 provides access to an interior volume 708 of the hollow structural element 702 at a non-end of the element 702. At least one cable accesses the interior volume 706 of the hollow structural element 702 via the cable access opening 706. Specifically, an electrical cord has an electrical receptacle 710 at one end that protrudes from the hollow structural element 702 at the cable access opening 706.

A protective member 712 resides at the opening 706 to prevent wear or fraying of the cord that extends through the opening. In the embodiment shown, the hollow structural element 700 is made of a metal such as steel or aluminum. Constant friction between the cord and an edge of the opening 706 could cause fraying. The protective member 712 mounts in the opening 706 and can be made such that the surface facing the cord has substantially no sharp edges to cause wear. The member 712 can be made from metal, plastic, rubber or another material installable into opening 706 such as silicone or caulk. In this embodiment, opening 706 is circular, and protective member 712 is a ring configured to fit within opening 706.

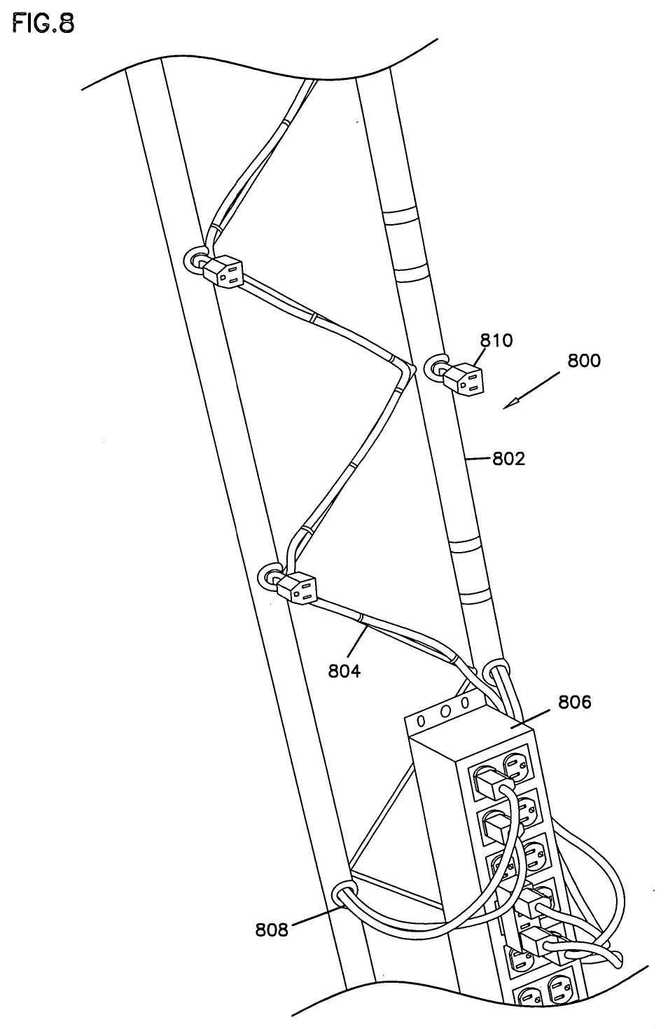

Referring now to FIG. 8, a section of a lighting stand 800 with an integrated receptacle manifold is shown according to a possible embodiment of the present disclosure. The lighting stand 800 includes hollow structural elements 802. The stand 800 also includes support bars 804. The support bars 804 are mounted between two hollow structural elements 802 and support the elements 802 in parallel.

A receptacle manifold 806 is mounted on at least one of the structural elements 802 or support bars 804. The receptacle manifold 806 includes multiple electrical receptacles mounted in a common structure. The receptacle manifold can include an electrical cord having an electrical plug (not shown) that is used to provide a common power source to all receptacles in the receptacle manifold 806. One or more electrical cords 808, having plugs thereon, operably connect to the manifold 806. The electrical cords 808 at least partially reside in an internal volume of at least one of the structural elements 802. An end of the electrical cord 808 distant from the receptacle manifold 806, having an electrical receptacle 810 thereon, protrudes from a structural element 802 and provides a power source closer to mounting locations of lights or other electric equipment on the lighting stand 800.

As shown, not all electrical cords used in conjunction with the lighting stand 800 reside at least partially within one of the elements 802. However, by using the system and method as disclosed herein a user of a lighting stand improves the appearance and safety of such a stand by incorporating at least one cable used in conjunction with the stand.

It is understood that the receptacle manifold 806 may incorporate electrical connections other than an AC power source. For example, the receptacle manifold could be an audio switchboard, a lighting control board, or a manifold capable of providing a convenient connection point for other electrically powered devices residing on the lighting stand 800. In the case of an AC power receptacle manifold, an electrical cable and plug can electrically connect the manifold to an AC power source. In the case of a lighting or sound control board, an appropriately configured receptacle manifold can connect to lighting or volume controls, such as may be located at a DJ booth as shown in FIG. 1.

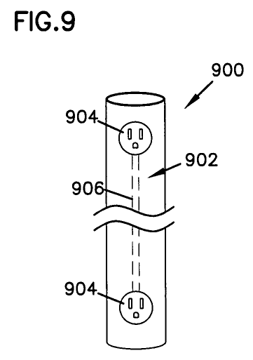

Referring now to FIG. 9, a perspective view of a portion of a hollow structural element 900 is shown according to a possible embodiment of the present disclosure. The hollow structural element has an internal volume 902. One or more electrical receptacles 904 (or any other connectors consistent with the present disclosure) are configured such that they reside at least partially in the internal volume 902. In some such embodiments, the electrical receptacles 904 can be oriented such that a connection area of the receptacle 904 creates a substantially continuous surface with the exterior surface of the hollow structural element 900. In any embodiment, the electrical receptacles 904 or other cables remain user-accessible external to the stand.

It is understood that the hollow structural element 900 can be disassembled into two or more hollow structural segments, such as described in conjunction with the embodiments shown in FIGS. 2-4.

It is understood that the stand configurations disclosed, having hollow volumes for passing electrical wires or other wires and cables therethrough, can be used for other applications and in other fields, rather than just being limited to lighting and speakers for music or other displays. For example, a stand for a construction site can include electrical receptacles from which to access power for power tools, lights, or other electrical equipment. In various applications, the stand of the invention may be termed a lighting stand, a speaker stand, or an electrical stand. The scope and application of the present invention is not limited by the name given to the stand.

Further, it is understood that the stand configuration does not require all cables used in conjunction with the stand to be passed through the hollow structural elements of the stand. A stand having at least one cable residing at least partially within one of its hollow structural elements and having connective access on at least one non-end of the structural element is contemplated by the present disclosure.

The above specification and examples provide a complete description of the manufacture and use of the construction of the invention. Since many embodiments of the invention can be made without departing from the spirit and scope of the invention, the invention resides in the claims hereinafter appended.

The claimed invention is:

1. A stand with integrated cabling comprising:
(a) one or more structural elements, wherein at least one of the structural elements is a hollow structural element having an internal volume;
(b) first and second cable access openings positioned along the length of the hollow structural element, the first and second cable access openings located a predetermined distance apart;
(c) at least one cable having first and second connectors at opposing ends and having a length greater than the predetermined distance, the cable at least partially residing within the internal volume such that the first and second connectors reside external to the hollow structural element and the at least one cable passes through the first and second cable access openings.

2. The stand of claim 1, wherein the hollow structural element is tubular.

3. The stand of claim 1, wherein the predetermined distance is less than the length of the hollow structural element.

4. The stand of claim 1 wherein at least one of the first and second cable access openings is located at a non-end of the hollow structural element.

5. The stand of claim 1, wherein the hollow structural element separates into at least a first hollow structural segment having a first internal volume and a second hollow structural segment having a second internal volume connectable at a union such that the internal volume is formed comprising the first internal volume and the second internal volume.

6. The stand of claim 5 wherein the first hollow structural segment has a first joint and the second hollow structural segment has a second joint, wherein the first joint and second joint have complementary cable connectors and form the union.

7. The stand of claim 6 wherein the complementary cable connectors form the at least one cable.

8. The stand of claim 6 wherein the complementary cable connectors comprise an electrical plug and an electrical receptacle.

9. The lighting stand of claim 6 wherein the complementary cable connectors comprise male and female audio/video connectors.

10. The stand of claim 5 wherein the cable is removable from the hollow structural element for disassembly.

11. The stand of claim 1, further comprising a receptacle manifold mounted on the lighting stand.

12. The stand of claim 11 wherein the at least one cable is operably connected to the receptacle manifold.

13. The stand of claim 1, further comprising a protective member located at each cable access opening.

14. The stand of claim 1 wherein all of the structural elements are hollow.

15. The stand of claim 1 wherein a portion of at least one of the first and second connectors resides in the internal volume.

16. A method of arranging cables for use with a stand, the method comprising:
assembling a stand having at least one hollow structural element having an internal volume and first and second cable access openings positioned along the length of the hollow structural element; and
passing at least one cable having first and second connectors at opposing ends and a length greater than the distance between the first and second cable access openings through said first and second cable access openings, whereby said first connector protrudes from said first opening and said second connector protrudes from said second opening and at least a portion of said cable resides within the internal volume.

17. The method of claim 16, wherein the method includes assembling the at least one hollow structural element from at least a first hollow structural segment and a second hollow structural segment connectable at a union to form the internal volume.

18. The method of claim 17, wherein the method includes connecting a first segment of the at least one cable to a second segment of the at least one cable at the union.

19. The method of claim 17, wherein the passing of the at least one cable occurs after the assembling of the at least one hollow structural element.

20. A stand with integrated cabling comprising:
(a) one or more structural elements, wherein at least one of the structural elements is a hollow structural element having an internal volume, the one or more structural elements forming a stand;
(b) first and second cable access openings, the openings positioned at non-ends of one of the hollow structural elements, the first and second cable access openings positioned a predetermined distance apart;
(c) at least one cable having first and second connectors at opposing ends and having a length greater than the predetermined distance, the cable at least partially residing within the internal volume of the hollow structural element such that the first and second connectors reside external to the hollow structural elements and the at least one cable passes through the first and second cable access openings; and
(d) a receptacle manifold attached to a structural element, the receptacle manifold comprising connectors operably connected to the at least one cable and a source cable operably connected to an electrical source.
